(19) United States
(12) Patent Application Publication
(10) Pub. No.: US 2018/0071994 A1
(43) Pub. Date: Mar. 15, 2018

(54) METHOD OF FABRICATING RETENTION ASSEMBLY STRUCTURES

(71) Applicant: TYCO ELECTRONICS CORPORATION, Berwyn, PA (US)

(72) Inventors: Xiaoming LUO, Hummelstown, PA (US); Charles David FRY, New Bloomfield, PA (US)

(21) Appl. No.: 15/261,158

(22) Filed: Sep. 9, 2016

(51) Int. Cl. B29C 65/70; B29C 47/02; B29C 47/88; B29C 47/92

(52) U.S. Cl. CPC B29C 65/70; B29C 47/026; B29K 2101/12; B29C 47/92; B29C 47/8815

(57) ABSTRACT

A connector and a method of retaining a contact in a housing. The method includes: inserting the contact into a contact receiving cavity of the housing; applying extruded material in layers into the contact receiving cavity with a precision controlled nozzle; filling voids in the contact receiving cavity layer by layer until the contact receiving cavity is filled; and cooling or curing the extruded material, allowing the extruded material to bond with a wall of the contact receiving cavity. The contact is securely maintained in the contact receiving cavity of the housing by the extruded material. The connector having a contact positioned in a contact receiving cavity of a housing. Extruded material is positioned in the contact receiving cavity. The extruded material is bond to walls of the contact receiving cavity, wherein the extruded material securely maintains the contact in the contact receiving cavity of the housing.

### FIELD OF THE INVENTION

The present invention is directed to a method of manufacture and assembly of components. In particular, the invention is directed to a method of fabricating retention assembly structures with extrusion based layered deposition.

### BACKGROUND OF THE INVENTION

Heat staking is a well known technology for connecting two or more components together by permanently forming, e.g. molding, or deforming a thermoplastic component with heat. Current heat staking processes generally consist of heating thermoplastic components with some types of heat sources, forming the softened thermoplastic materials into a certain shapes, and cooling the thermoplastic materials down in a manner such that the components mechanically locked together.

Generally, heat staking uses the controlled melting and reforming of a plastic stud or boss to capture or lock another plastic or metal component of an assembly in place. The plastic stud protrudes through a hole in the component to be locked in place. The heated thermal tip contacts the top of the stud, which melts and fills the volume of the tip cavity to produce a head, locking the component in place. The progressive melting of plastic under continuous pressure forms the head. When staking, the right combination of heat and pressure for the application is critical.

When performing heat staking, appropriate tooling and fixtures are required to ensure proper heating of the material. In addition, retainers, molds, pushers and other known devices are required to properly shape retention features to provide the required retention.

While heat staking has been effective with the standard manufacturing operations, it would be beneficial to provide an alternative method to create retention assembly structure without the need to use the type of tooling and fixtures required for heat staking.

### SUMMARY OF THE INVENTION

An object of the present innovation is to provide a method to retain parts or components without the need for heat staking.

An object of the present innovation is to provide a method to retain parts or components with extrusion based layered deposition technology.

An object of the present innovation is to provide a method to create retention assembly features for connecting two or more components together by placing one object into another and precisely laying down thermoplastic filament materials.

An object of the present innovation is to provide a method to retain parts or components which does not require the presence of tooling and fixtures, such as molds, retainers and pushers.

An object of the present innovation is to provide a method to retain parts or components which is flexible to form retention features with different shapes and dimensions.

An embodiment is directed to a method of retaining a contact in a housing. The method includes: inserting the contact into a contact receiving cavity of the housing; applying extruded material in layers into the contact receiving cavity with a precision controlled nozzle; filling voids in the contact receiving cavity layer by layer until the contact receiving cavity is filled; and cooling or curing the extruded material, allowing the extruded material to bond with a wall of the contact receiving cavity. The contact is securely maintained in the contact receiving cavity of the housing by the extruded material.

An embodiment is directed to a method of retaining a first component in a second component. The method includes: inserting the first component into a receiving cavity of the second component; positioning a retention member of the first component in a retention member receiving section of the receiving cavity of the second component to maintain the first component in the receiving cavity when a force is applied to the first component in an axial direction; applying extruded material in layers into the receiving cavity with a precision controlled nozzle; filling voids in the receiving cavity layer by layer until the receiving cavity is filled; and cooling or curing the extruded material, allowing the extruded material to bond with a wall of the receiving cavity. The first component is securely maintained in the receiving cavity of the second component by the extruded material.

An embodiment is directed to a connector having a contact positioned in a contact receiving cavity of a housing. Extruded material is positioned in the contact receiving cavity. The extruded material is bonded to walls of the contact receiving cavity, wherein the extruded material securely maintains the contact in the contact receiving cavity of the housing.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an illustrative contact positioned proximate an illustrative housing, the housing having a contact receiving cavity for receiving the terminal therein.

FIG. 2 is a perspective view of the contact and housing of FIG. 1, with the contact positioned in the contact receiving cavity.

FIG. 3 is a perspective view of the contact and housing of FIG. 2, illustrating the deposition of layered extrusion material being deposited in the contact receiving cavity.

FIG. 4 is a perspective view of the contact and housing of FIG. 3, illustrating the contact receiving cavity filled with the layered extrusion material to retain the contact in the contact receiving cavity.

FIG. 5 is a perspective view of an alternate illustrative contact positioned proximate an illustrative housing, the housing having a contact receiving cavity for receiving the terminal therein.

FIG. 6 is a perspective view of the contact and housing of FIG. 5, with the contact positioned in the contact receiving cavity.

FIG. 7 is a perspective view of the contact and housing of FIG. 6, illustrating the deposition of layered extrusion material being deposited in the contact receiving cavity.

FIG. 8 is a perspective view of the contact and housing of FIG. 7, illustrating the contact receiving cavity filled with the layered extrusion material to retain the contact in the contact receiving cavity.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Extrusion based layered deposition is a method of melting thermoplastic polymers, extruding them out of a nozzle and laying down extruded filaments to form a certain type of structures with precision motion control mechanism. When thermoplastic material flows out of the nozzle, it is in a filament shape and still in semi-liquid state.

In the present invention, as described and illustrated herein, the filament from the extrusion based layered deposition is positioned into designated positions with precision motion control to fabricate retention assembly structures with maintain a contact within a housing, as will be more fully described.

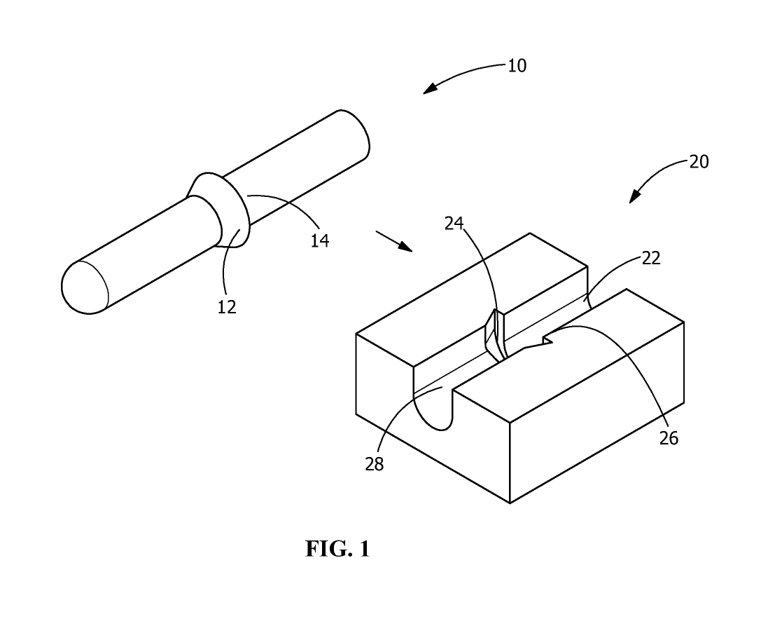

Referring to FIG. 1, an illustrative contact or pin 10 and an illustrative housing 20 are shown. The pin 10 has a retention member 12 positioned thereon. In the embodiment shown, the retention member 12 is a radially extending projection with a shoulder 14. However, other types of retention members may be used without departing from the scope of the invention.

The housing 20 has a contact receiving cavity 22 with a radially extending recess 24 for receiving the retention member 12 therein. The recess 24 has a wall 26 positioned therein. However, other configurations of the contact receiving cavity and recess be used without departing from the scope of the invention. In addition, the housing 20 may include multiple contact receiving cavities 22 for receiving multiple pins 10 therein. The contact receiving cavity 22 has the same or larger profile than the pin 10 to allow for the pin 10 to be easily inserted into the contact receiving cavity 22.

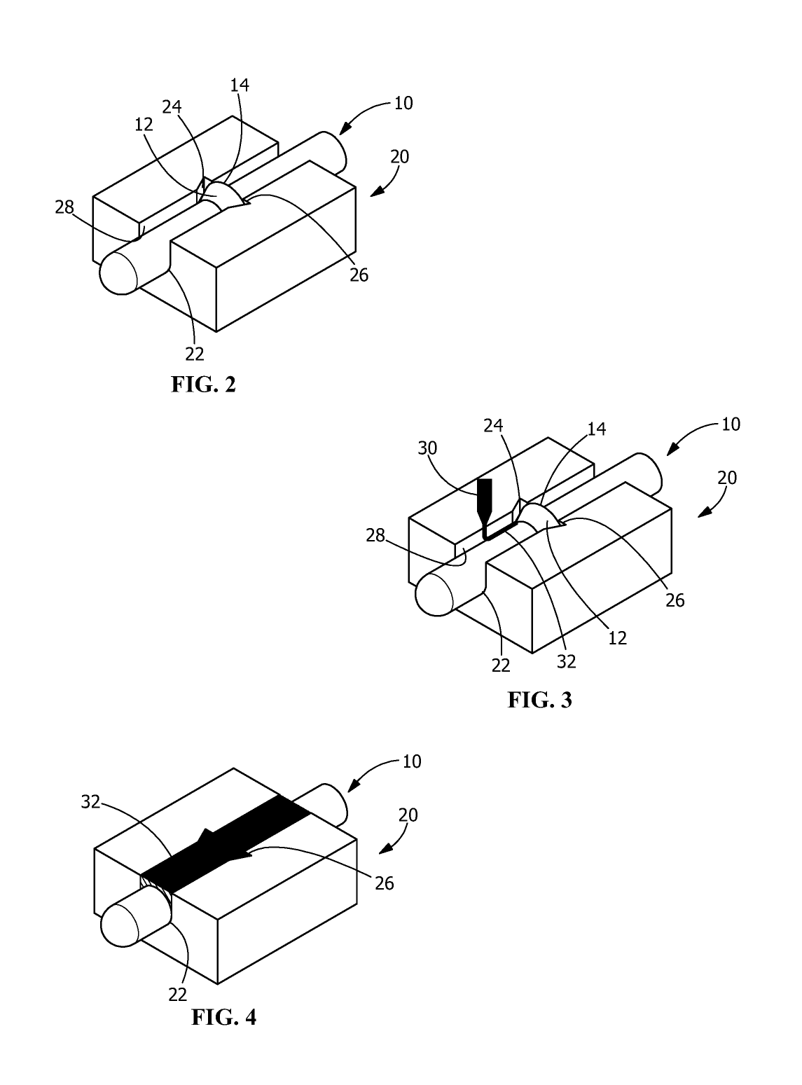

Referring to FIG. 2, the pin 10 is positioned in the contact receiving cavity 22. In this position, the retention members 12 is received in the recess 24. The shoulder 14 is positioned proximate the wall 26. The retention member 12 and shoulder 14 cooperate with the recess 24 and wall 26 to secure the pin 10 in the cavity 22 when forces are applied to the pin in the axial direction.

With the pin 10 properly positioned in the cavity 22, nozzle 30 is moved into alignment with the cavity 22, as shown in FIG. 3. With the nozzle 30 properly positioned, extruded material or filament 32 is extruded from the nozzle 30 into the cavity 22. In the embodiment shown, the nozzle 30 is moved first in a direction which is essentially parallel to the longitudinal axis of the cavity 22. This allows the filament 32 to flow between the pin 10 and the wall 28 of the cavity 22 to fill void spaces between the pin 10 and the wall 28 of the cavity 22. The nozzle 30 is then moved essentially perpendicular to the longitudinal axis of the cavity 22 and then essentially parallel to the longitudinal axis of the cavity 22 until the respective layer is complete. However, the nozzle 30 may be moved in multiple directions, such as, but not limited to, at an angle with respect to the longitudinal axis, without departing from the scope of the invention.

The procedure is repeated from the bottom to the top in a layer by layer manner until the entire cavity 22 is filled with filament 32, as shown in FIG. 4. The semi-liquid filament 32 is cooled, cured or hardens and bonds together and bonds with the wall 28 of the cavity 22 to provide and maintain a secure connection there between. The filament 32 and housing 20 may be made from the same or different materials, which may include, but is not limited to, thermoplastic material. The housing may be made using additive manufacturing methods or other methods.

As the filament 32 fills the voids or spaces between the pin 10 and housing 20 and the other voids or spaces in the cavity 22, the filaments 32 cooperates with the housing 20 and the pin 10 to securely maintained the pin 10 in the cavity 22. This allows the retention member 12 and shoulder 14 to cooperate with the recess 24, wall 26 and filament 32 to more securely maintain the pin 10 in position in the cavity 22 when forces are applied to the pin in the axial direction.

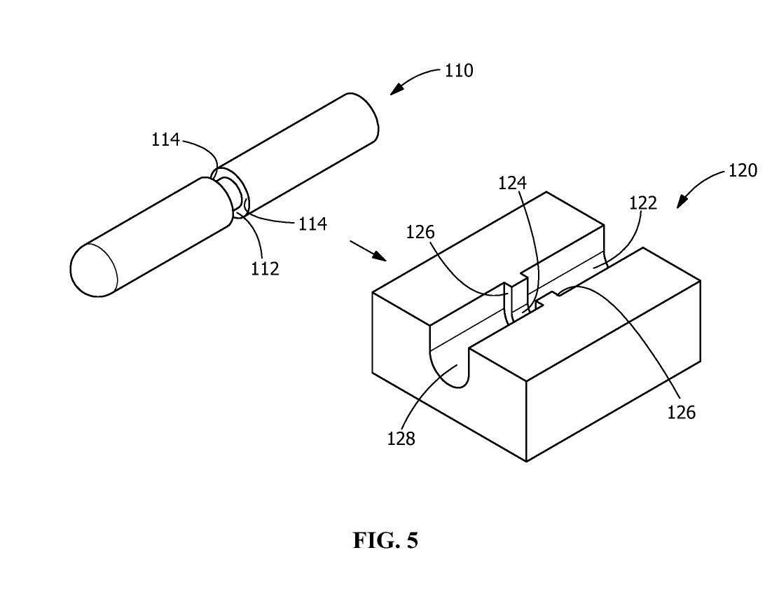

Referring to FIG. 5, an alternate illustrative contact or pin 110 and an illustrative housing 120 are shown. The pin 110 has a retention member 112 positioned thereon. In the embodiment shown, the retention member 112 is a radially extending slot or groove with shoulders 114. However, other types of retention members may be used without departing from the scope of the invention.

The housing 120 has a contact receiving cavity 122 with a radially extending projection 124 for cooperating with the retention member 112. The projection 124 has a retention shoulders 126 positioned thereon. However, other configurations of the contact receiving cavity and recess be used without departing from the scope of the invention. In addition, the housing 120 may include multiple contact receiving cavities 122 for receiving multiple pins 110 therein. The contact receiving cavity 122 has the same or larger profile than the pin 110 to allow for the pin 110 to be easily inserted into the contact receiving cavity 122.

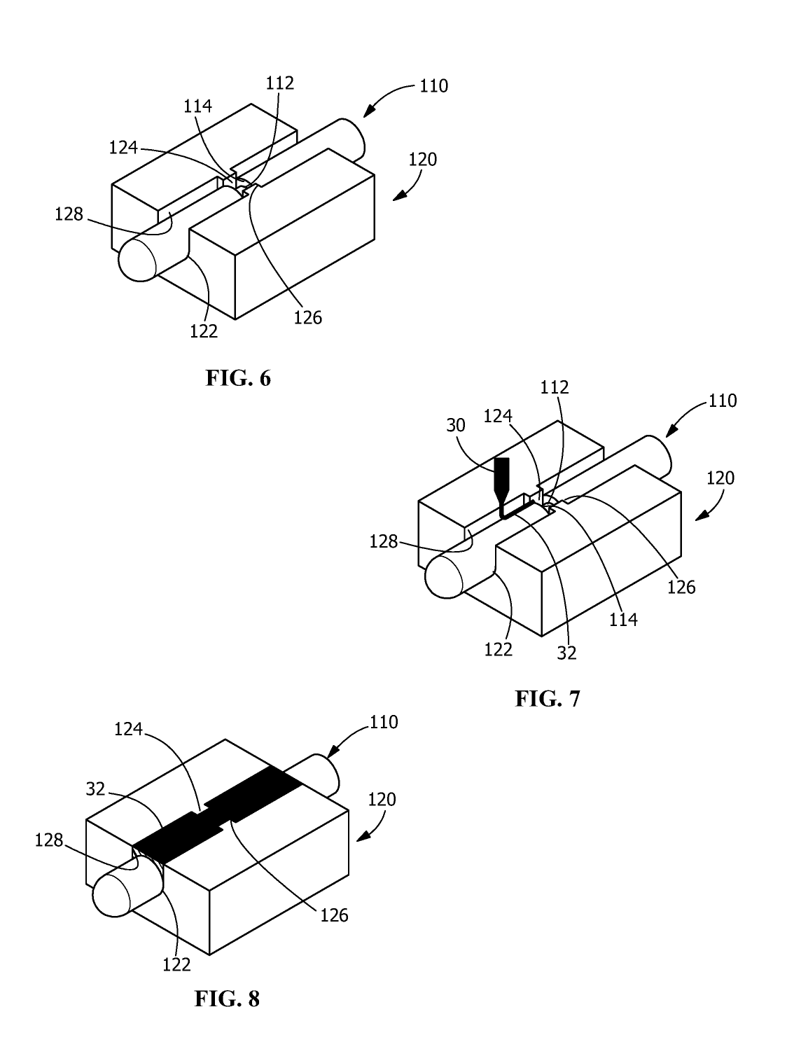

Referring to FIG. 6, the pin 110 is positioned in the contact receiving cavity 122. In this position, the projection 124 is positioned in the retention members 112. The shoulders 114 is positioned proximate the shoulder 126. The retention member 112 and shoulders 114 cooperate with the projection 124 and shoulders 126 to secure the pin 110 in the cavity 122 when forces are applied to the pin in the axial direction.

With the pin 110 properly positioned in the cavity 122, nozzle 30 is moved into alignment with the cavity 122, as shown in FIG. 7. With the nozzle 30 properly positioned, extruded material or filament 32 is extruded from the nozzle 30 into the cavity 122. In the embodiment shown, the nozzle 30 is moved first in a direction which is essentially parallel to the longitudinal axis of the cavity 122. This allows the filament 32 to flow between the pin 110 and the wall 128 of the cavity 122 to fill void spaces between the pin 110 and the wall 128 of the cavity 122. The nozzle 30 is then moved essentially perpendicular to the longitudinal axis of the cavity 122 and then essentially parallel to the longitudinal axis of the cavity 122 until the respective layer is complete. However, the nozzle 30 may be moved in multiple directions, such as, but not limited to, at an angle with respect to the longitudinal axis, without departing from the scope of the invention.

The procedure is repeated from the bottom to the top in a layer by layer manner until the entire cavity 122 is filled with filament 32, as shown in FIG. 8. The semi-liquid filament 32 cools, cures or hardens and bonds together and bonds with the wall 128 of the cavity 122 to provide and maintain a secure connection there between. The filament 32 and housing 120 may be made from the same or different materials, which may include, but is not limited to, thermoplastic material. The housing may be made using additive manufacturing methods or other methods.

As the filament 32 fills the voids or spaces between the pin 110 and housing 120 and the other voids or spaces in the cavity 122, the filament 32 cooperates with the housing 120 and the pin 110 to securely maintain the pin 110 in the cavity 122. This allows the retention member 112 and shoulder 114 to cooperate with the projection 124, shoulders 126 and filament 32 to more securely maintain the pin 110 in position in the cavity 122 when forces are applied to the pin in the axial direction.

This method of fabricating retention assembly structures allows two or more components, such as contacts and housings, to be secured to each other by precisely applying filament material as needed. The does not require the presence of addition tooling or fixtures, such as molds, retainers or pushers. The method is flexible and can be used with contacts and cavities of different dimensions and shapes.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials and components, without departing from the spirit or essential characteristics thereof. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A method of retaining a contact in a housing, the method comprising:
inserting the contact into a contact receiving cavity of the housing;
applying extruded material in layers into the contact receiving cavity with a precision controlled nozzle;
filling voids in the contact receiving cavity layer by layer until the contact receiving cavity is filled;
cooling or curing the extruded material, allowing the extruded material to bond with a wall of the contact receiving cavity;
wherein the contact is securely maintained in the contact receiving cavity of the housing by the extruded material.

2. The method of claim 1, comprising:
moving the nozzle in a direction which is essentially parallel to a longitudinal axis of the contact receiving cavity when the extruded material is first applied, allowing the extruded material to flow between the contact and a wall of the contact receiving cavity to fill the voids between the contact and the wall of the contact receiving cavity.

3. The method of claim 2, comprising:
moving the nozzle after a first row of material is complete until a respective layer is complete.

4. The method of claim 1, comprising:
positioning a retention member of the contact in a retention member receiving section of the contact receiving cavity to maintain the contact in the contact receiving cavity when a force is applied to the contact in an axial direction.

5. The method of claim 1, comprising:
inserting a retention member of the contact in a retention member receiving recess of the contact receiving cavity prior to applying the extruded material.

6. The method of claim 5, wherein the retention member is a radially extending projection.

7. The method of claim 1, comprising:
positioning a retention member of the contact in engagement with a projection positioned the contact receiving cavity prior to applying the extruded material.

8. The method of claim 7, wherein the retention member is a radially extending groove.

9. A method of retaining a first component in a second component, the method comprising:
inserting the first component into a receiving cavity of the second component;
positioning a retention member of the first component in a retention member receiving section of the receiving cavity of the second component to maintain the first component in the receiving cavity when a force is applied to the first component in an axial direction.
applying extruded material in layers into the receiving cavity with a precision controlled nozzle;
filling voids in the receiving cavity layer by layer until the receiving cavity is filled;
cooling or curing the extruded material, allowing the extruded material to bond with a wall of the receiving cavity;
wherein the first component is securely maintained in the receiving cavity of the second by the extruded material.

10. The method of claim 9, comprising:
moving the nozzle in a direction which is essentially parallel to a longitudinal axis of the receiving cavity when the extruded material is first applied, allowing the extruded material to flow between the first component and a wall of the receiving cavity of the second component to fill the voids between the first component and the wall of the receiving cavity;
moving the nozzle after a first row of material is complete until a respective layer is complete.

11. The method of claim 10, wherein the retention member receiving section is a retention member receiving recess.

12. The method of claim 11, wherein the retention member is a radially extending projection.

13. The method of claim 10, wherein the retention member receiving section is a projection positioned.

14. The method of claim 12, wherein the retention member is a radially extending groove.

15. A connector comprising:
a contact positioned in a contact receiving cavity of a housing;
extruded material positioned in the contact receiving cavity, the extruded material is bond to walls of the contact receiving cavity,
wherein the extruded material securely maintains the contact in the contact receiving cavity of the housing.

16. The connector as recited in claim 9, wherein the contact has a retention member which is positioned in a retention member receiving section of the contact receiving cavity to maintain the contact in the contact receiving cavity when a force is applied to the contact in an axial direction.

17. The connector as recited in claim 10, wherein the retention member receiving section is a retention member receiving recess.

18. The connector as recited in claim 11, wherein the retention member is a radially extending projection.

19. The connector as recited in claim 10, wherein the retention member receiving section is a projection positioned.

20. The connector as recited in claim 13, wherein the retention member is a radially extending groove.
